(19) United States
(12) Patent Application Publication
(10) Pub. No.: US 2015/0271451 A1
(43) Pub. Date: Sep. 24, 2015

(54) IMAGE CAPTURING SYSTEM

(71) Applicant: PFU Limited, Ishikawa (JP)

(72) Inventor: Masayoshi HAYASHI, Ishikawa (JP)

(21) Appl. No.: 14/321,446

(22) Filed: Jul. 1, 2014

(30) Foreign Application Priority Data
Mar. 18, 2014 (JP) 2014-055589

(51) Int. Cl. H04N 7/18; G06T 7/00; H04N 5/225; G03B 15/03

(52) U.S. Cl. CPC H04N 7/18; G03B 15/03; G06T 7/004; H04N 5/2252; H04N 5/2256

(57) ABSTRACT

An image capturing system includes a portable image capturing device and a lighting apparatus. The portable image capturing device includes an image capturing unit, a posture detection sensor detecting a posture of the portable image capturing device, and a control unit. The lighting apparatus includes a base part to be disposed on a medium installation face, an arm part, a top part extending from the arm part, an image-capturing-device mounting part arranged on the top part, a lighting unit, a communication unit performing mutual communication between the portable image capturing device, and a notification unit that makes a notification when the posture detection sensor detects that the portable image capturing device is mounted in a predetermined posture with respect to the image-capturing-device mounting part in a state in which the image capturing unit is capable of performing photographing controlled by the control unit.

### CROSS-REFERENCE TO RELATED APPLICATIONS

The present application claims priority to and incorporates by reference the entire contents of Japanese Patent Application No. 2014-055589 filed in Japan on Mar. 18, 2014.

### BACKGROUND OF THE INVENTION

1. Field of the Invention

The present invention relates to an image capturing system.

2. Description of the Related Art

In recent years, portable image capturing devices have become widely used to increase opportunities for readily photographing images. To photograph a clear image, the image capturing device may be connected to other device such as a fixing device. In such a case, when the image capturing device recognizes that the image capturing device is connected to the other device, there is a case where the image capturing device changes a setting thereof to a setting, which is previously stored therein, for a case where the image capturing device is connected to the other device, and performs photographing with this setting (for example, refer to Japanese Patent Application Laid-open No. 4-336775 and Japanese Patent Application Laid-open No. 2007-110239).

Depending on a connection mechanism between the image capturing device and other device, attachment/detachment thereof may be complicated. However, the connection is preferably as simple as possible. For example, when the image capturing device is mounted on a mounting face, device having the mounting face is preferably connected to the image capturing device. However, in a mode in which the image capturing device is mounted on the mounting face, a user cannot easily recognize whether the image capturing device is appropriately mounted and connected. Accordingly, in a case of connecting the image capturing device to the device by mounting the image capturing device on the mounting face, it has been difficult to mount the image capturing device in an appropriate state.

### SUMMARY OF THE INVENTION

It is an object of the present invention to at least partially solve the problems in the conventional technology.

According to an aspect of the invention, an image capturing system comprises a portable image capturing device and a lighting apparatus. The portable image capturing device includes an image capturing unit, a posture detection sensor that detects a posture of the portable image capturing device, and a control unit that controls the portable image capturing device. The lighting apparatus includes a base part to be disposed on a medium installation face on which a medium is mounted, an arm part extending upward from the base part, a top part extending from the arm part and facing the medium installation face, an image-capturing-device mounting part arranged on the top part to mount the portable image capturing device thereon enabling the image capturing unit to photograph the medium installation face, a lighting unit that irradiates the medium installation face with light, a communication unit that performs mutual communication between the lighting apparatus and the portable image capturing device, and a notification unit that makes a notification when the posture detection sensor detects that the portable image capturing device is mounted in a predetermined posture with respect to the image-capturing-device mounting part in a state in which the image capturing unit is capable of performing photographing controlled by the control unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of an image capturing system according to an embodiment of the present invention;

FIG. 2 is a side view of the image capturing system illustrated in FIG. 1;

FIG. 3 is a diagram viewed along the A-A line in FIG. 2;

FIG. 4 is a perspective view of a lighting apparatus illustrated in FIG. 1;

FIG. 5 is a functional block diagram of the image capturing system illustrated in FIG. 1;

FIG. 6 is a flowchart illustrating a processing procedure when photographing is performed with the image capturing system illustrated in FIG. 1;

FIG. 7 is an explanatory diagram when a portable image capturing device is mounted on an image-capturing-device mounting part;

FIG. 8 is an explanatory diagram when the portable image capturing device is inappropriately mounted;

FIG. 9 is a perspective view when the portable image capturing device is appropriately mounted on the image-capturing-device mounting part;

FIG. 10 is a side view when the portable image capturing device is appropriately mounted on the image-capturing-device mounting part;

FIG. 11 is a flowchart illustrating a processing procedure in a case of detecting that the portable image capturing device is mounted on the image-capturing-device mounting part; and

FIG. 12 is a flowchart illustrating a processing procedure in a case of detecting that the portable image capturing device is removed from the image-capturing-device mounting part.

### DETAILED DESCRIPTION OF THE PREFERRED EMBODIMENTS

The following describes an embodiment of an image capturing system according to the invention in detail with reference to drawings. The invention is not limited by the embodiment. Components described in the embodiment below include a component that can be replaced with other component by those skilled in the art, an easily available component, or substantially the same component.

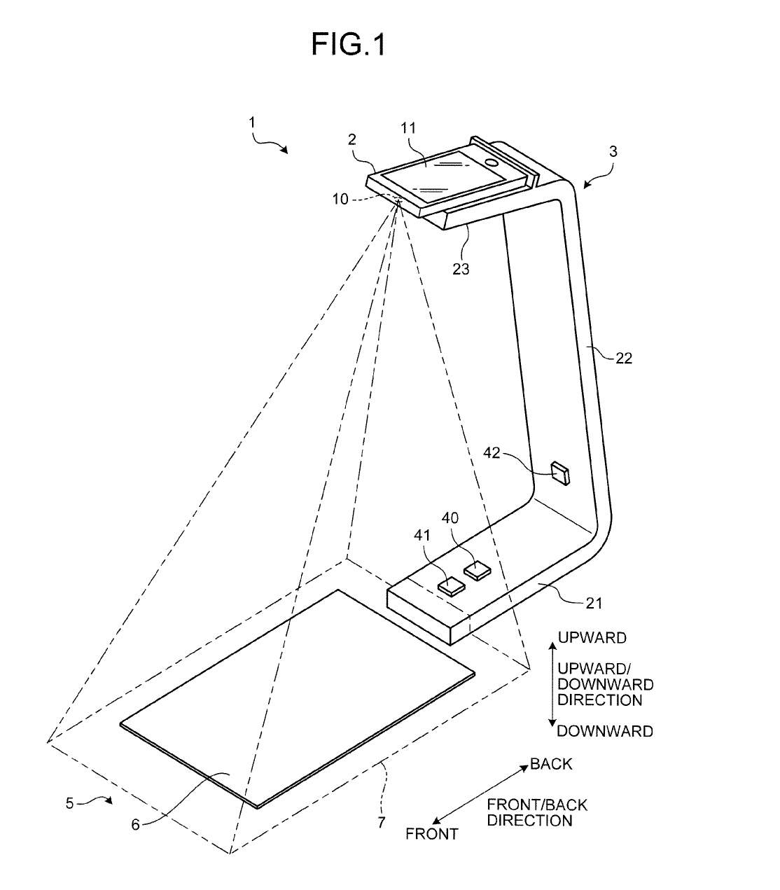

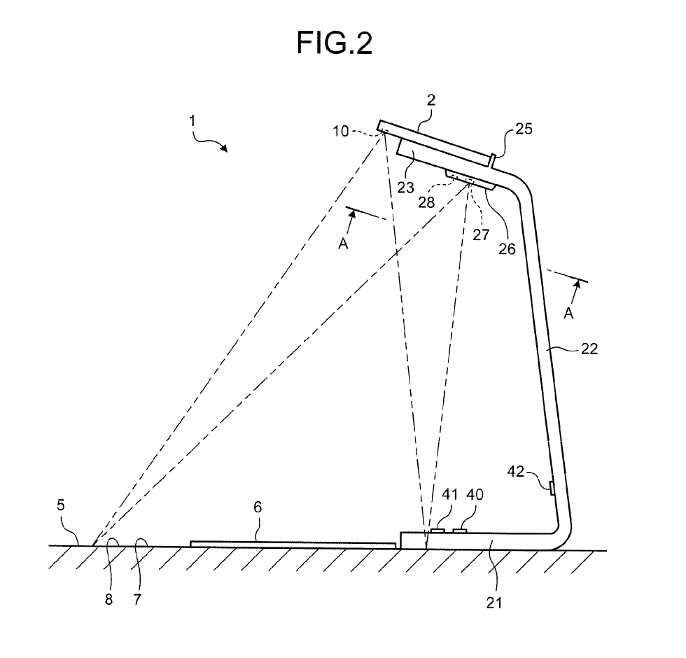

FIG. 1 is a perspective view illustrating a schematic configuration of an image capturing system according to an embodiment. FIG. 2 is a side view of the image capturing system illustrated in FIG. 1. This image capturing system 1 illustrated in FIGS. 1 and 2 is a scanner system for performing a scanning operation by photographing a medium 6 serving as a reading target disposed on a medium installation face 5 from above with a predetermined image capturing unit to generate image data of the medium 6. In the present embodiment, a portable image capturing device 2 having a camera function is used as the image capturing unit. As the portable image capturing device 2, for example, a smartphone having a camera function is used.

The image capturing system 1 according to the present embodiment includes the portable image capturing device 2 and a lighting apparatus 3 on which the portable image capturing device 2 can be mounted when scanning is performed by photographing with the portable image capturing device 2. The image capturing system 1 can acquire a scanned image of a predetermined area 7 to be photographed (hereinafter, photographed area 7) using the portable image capturing device 2 in a state in which the portable image capturing device 2 is mounted at a predetermined position of the lighting apparatus 3 (an image-capturing-device mounting part 30 described later). In the following description, the upward/downward direction in FIG. 1 will be described as the upward/downward direction of the image capturing system 1 and the lighting apparatus 3. Further, with respect to the image capturing system 1, specifically, with respect to a base unit 21, as disclosed in FIG. 1, a side facing the medium 6 is defined as the front side of the image capturing system 1 and the lighting apparatus 3, and an opposite side to the front side is defined as the back side of the image capturing system 1 and the lighting apparatus 3. A direction from the back side of the image capturing system 1 toward the front side of the image capturing system is defined as a front direction, and a direction opposite to the front direction is defined as a back direction. The front side of FIG. 1 is assumed to be the forward direction of the image capturing system 1 and the lighting apparatus 3, and the back side of FIG. 1 is assumed to be the rearward direction of the image capturing system 1 and the lighting apparatus 3.

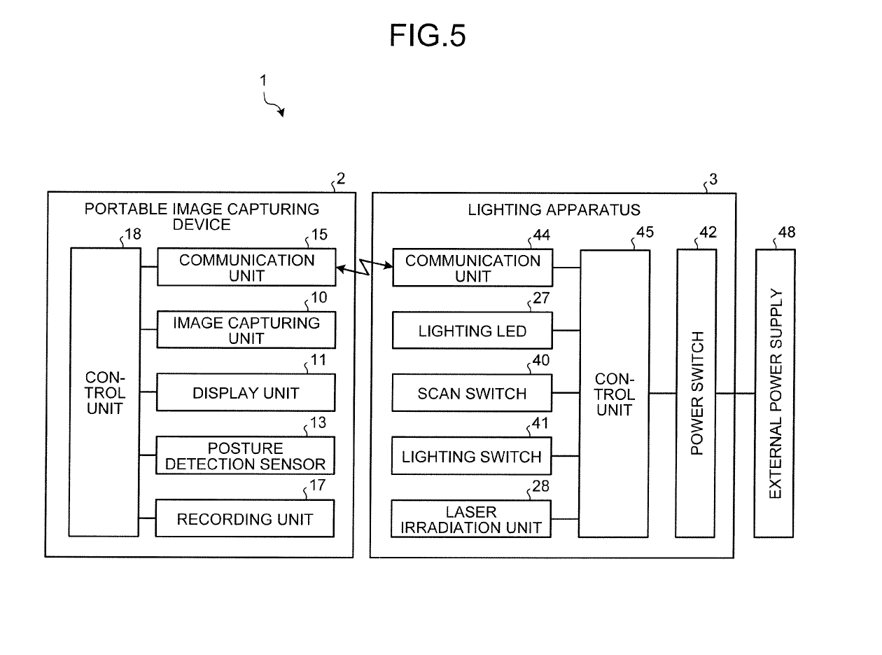

The portable image capturing device 2 is formed in a substantially rectangular plate-like shape, and an image capturing unit 10 performing a camera function is disposed on the back surface thereof. The image capturing unit 10 can perform a scanning operation in response to an operation command from a control unit 18 (refer to FIG. 5) of the portable image capturing device 2. In a state in which the portable image capturing device 2 is mounted on the image-capturing-device mounting part 30 of the lighting apparatus 3, the image capturing unit 10 can photograph the entire predetermined photographed area 7 and generate a scanned image including the entire photographed area 7. A display unit 11 for displaying various types of information is provided on a surface of the portable image capturing device 2 opposite to a surface on which the image capturing unit 10 is provided. The display unit 11 displays various types of information in operating the portable image capturing device 2, image information in photographing with the image capturing unit 10, and the like.

The lighting apparatus 3 includes three members, that is, the base unit 21, an arm unit 22, and a top unit 23. Among these, the base unit 21 is arranged on the medium installation face 5. The arm unit 22 is connected to the upper surface of the base unit 21 and upwardly extends therefrom. As illustrated in FIGS. 1 and 2, the extending direction of the arm unit 22 may be inclined to the front side (the side on which the medium 6 is disposed) with respect to the vertically upward direction, may be inclined to the back side (the side opposite to the side on which the medium 6 is disposed), or may be the vertically upward direction.

The top unit 23 is connected to the arm unit 22 and extends therefrom facing the medium installation face 5. In the present embodiment, as illustrated in FIG. 2, the top unit 23 is connected to the upper end of the arm unit 22, extends from a height position connected to the arm unit 22 toward the front, and extends obliquely upward with respect to the horizontal direction.

The base unit 21, the arm unit 22, and the top unit 23 of the lighting apparatus 3 are integrally fixed to each other. In other words, a connecting portion between the base unit 21 and the arm unit 22 and a connecting portion between the arm unit 22 and the top unit 23 are fixedly disposed so as not to be deformed such as being rotated, detached/attached, or moved.

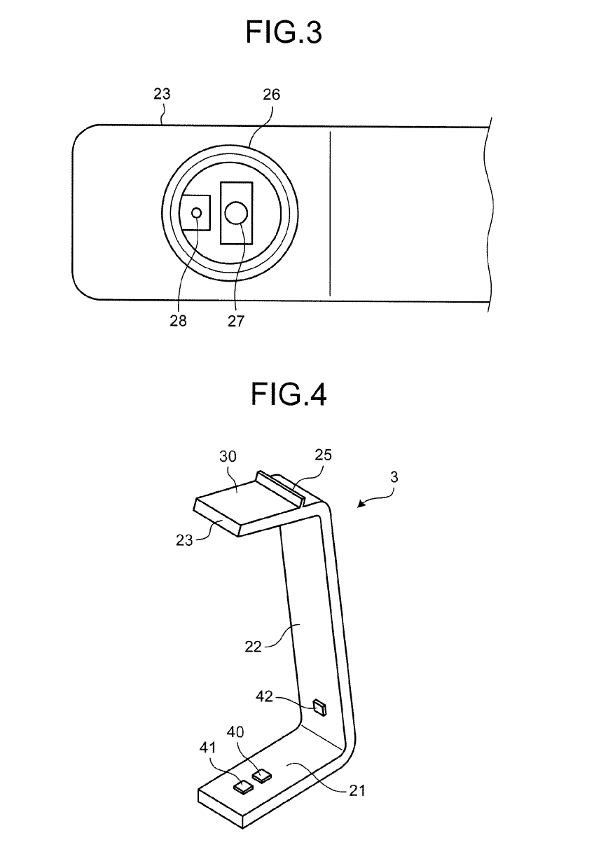

FIG. 3 is a diagram viewed along the A-A line in FIG. 2. An illumination unit 26 for illuminating the medium installation face 5 is arranged on the lower surface of the top part 23 of the lighting apparatus 3 that faces the medium installation face 5. The illumination unit 26 includes a light emitting diode (LED) for lighting 27 (hereinafter, lighting LED 27) serving as a lighting unit that illuminates the medium installation face 5 by irradiating the medium installation face 5 with light, and a laser irradiation unit 28 that irradiates the medium installation face 5 with laser light. Among these, the Lighting LED 27 is arranged on the lower surface of the top part 23 so that an irradiation range 8 thereof during light emission is substantially the same as the photographed area 7 of the portable image capturing device 2 and the photographed area 7 can be uniformly illuminated. The laser irradiation unit 28 is arranged on the lower surface of the top part 23 as an area display unit for displaying an area that can be photographed by the image capturing unit 10 of the portable image capturing device 2 on the medium installation face 5 with laser light.

FIG. 4 is a perspective view of the lighting apparatus illustrated in FIG. 1. On the upper surface 24 of the top unit 23 of the lighting apparatus 3, the image-capturing-device mounting part 30 is provided to mount the portable image capturing device 2 at a position where the medium 6 disposed on the medium installation face 5 can be photographed. The image-capturing-device mounting part 30 is formed of a plane inclined toward the back side and downward, that is, in a downward direction from the front side to the back side. The image-capturing-device mounting part 30 is configured such that the portable image capturing device 2 can be mounted thereon so that the image capturing unit 10 can photograph the medium installation face 5.

On the rear end side of the image-capturing-device mounting part 30 of the top part 23, that is, on a side where the arm unit 22 is positioned, and at the end of the image-capturing-device mounting part 30 in the front/back direction thereof, a movement regulation part 25 is provided to regulate the movement of the portable image capturing device 2 mounted on the image-capturing-device mounting part 30. The movement regulation part 25 has a plate-like shape extending in the right and left direction with thickness direction thereof extending substantially in the front/back direction, and is provided on the upper surface 24 across the right and left ends of the top unit 23. The height of the movement regulation part 25 is higher than that of the portable image capturing device 2 when the portable image capturing device 2 is mounted on the image-capturing-device mounting part 30.

In the image capturing system 1, an installation position of the image-capturing-device mounting part 30 is set such that a distance between the image capturing unit 10 and the medium installation face 5, which is appropriate for the image capturing unit 10 of the portable image capturing device 2 to photograph the entire predetermined photographed area 7 below, is kept when the portable image capturing device 2 is mounted on the image-capturing-device mounting part 30. Specifically, when the portable image capturing device 2 is mounted on the image-capturing-device mounting part 30 in such a state that an end of the portable image capturing device 2 at which the image capturing unit 10 is positioned abuts on the movement regulation part 25, the photographed area 7 of the portable image capturing device 2 includes a region to arrange the medium 6, i.e. the region being adjacent to the front of the base part 21 of the lighting apparatus 3, and a front upper surface portion of the base part 21.

A scan switch 40 and a lighting switch 41 are provided on the upper surface of the base unit 21 of the lighting apparatus 3. A power switch 42 is provided on the front surface of the arm unit 22. The scan switch 40, the Lighting switch 41, the power switch 42, the Lighting LED 27, and the laser irradiation unit 28 are electrically connected to a control unit 45 (refer to FIG. 5) included inside the lighting apparatus 3.

The scan switch 40 or the lighting switch 41 may be provided at a position other than the base unit 21. The power switch 42 may be provided at a portion other than the arm unit 22. The lighting apparatus 3 may be configured without the power switch 42, so that the lighting apparatus 3 will be turned on by insertion of an electric plug which the lighting apparatus 3 is equipped with into a socket.

The scan switch 40 is an input unit to receive, from a user, a scanning operation instruction for the portable image capturing device 2 to perform the scanning operation. That is, the scan switch 40 is provided as a photographing-instruction unit for instructing the image capturing unit. 10 to start photographing. The lighting switch 41 is an input unit for switching over ON and OFF of the Lighting LED 27. The power switch 42 is a switch for switching over conduction and non-conduction between an external power supply 48 and the lighting apparatus 3.

FIG. 5 is a functional block diagram of the image capturing system illustrated in FIG. 1. The portable image capturing device 2 composing the image capturing system 1 together with the lighting apparatus 3 includes the image capturing unit 10, the display unit 11, a posture detection sensor 13, a communication unit 15, a recording unit 17, and the control unit 18. The image capturing unit 10, the display unit 11, the posture detection sensor 13, the communication unit 15, and the recording unit 17 are electrically connected to the control unit 18.

The posture detection sensor 13 is a detector for detecting a posture of the portable image capturing device 2. The posture detection sensor 13 includes, for example, an acceleration sensor or a gyro sensor, so that it is possible to detect the posture of the portable image capturing device 2 such as a moving state or an inclination in various directions of the portable image capturing device 2.

The communication unit 15 can communicate with the lighting apparatus 3. The communication unit 15, for example, performs wireless communication via Bluetooth (registered trademark). The communication with the lighting apparatus 3 may be performed by a method other than Bluetooth. Any method, such as near field communication (NFC) or infrared communication, may be employed so long as wireless communication can be performed between the lighting apparatus 3 and the portable image capturing device 2 mounted on the image-capturing-device mounting part 30.

The recording unit 17 is a storage device for storing image data and the like photographed by the image capturing unit 10. The control unit 18 performs various types of arithmetic processing while communication with the lighting apparatus 3 through the communication unit 15 is performed or while photographing with the image capturing unit 10 is performed. The control unit 18 perform, for example, image processing so as to correct an image of the medium 6 on the medium installation face 5 photographed from obliquely above, using the image capturing unit 10 of the portable image capturing device 2 mounted on the image-capturing-device mounting part 30 of the inclined top unit 23, to be an image obtained by photographing the medium 6 from vertically above.

The lighting apparatus 3 includes the Lighting LED 27, the laser irradiation unit 28, the scan switch 40, the lighting switch 41, the power switch 42, a communication unit 44, and the control unit 45. The Lighting LED 27, the laser irradiation unit 28, the scan switch 40, the lighting switch 41, the power switch 42, and the communication unit 44 are electrically connected to the control unit 45.

The communication unit 44 can communicate with the communication unit 15 of the portable image capturing device 2 using Bluetooth and the like. The portable image capturing device 2 and the lighting apparatus 3 can wirelessly communicate with each other through respective communication units 15 and 44.

The control unit 45 is configured to perform driving control of the Lighting LED 27 or transmit a control signal to the communication unit 44 corresponding to an input operation on the scan switch 40 or the lighting switch 41 so as to perform light emission control of the Lighting LED 27 or control the communication between the lighting apparatus 3 and the portable image capturing device 2.

The power switch 42 is interposed between the external power supply 48 and the control unit 45, and can switch over an operation state and a stopping state of the lighting apparatus 3 by switch over conduction (On) and non-conduction (Off) between the control unit 45 and the external power supply 48 through the input operation.

The image capturing system 1 according to the present embodiment is composed as described above. Operations thereof are explained below. The lighting apparatus 3 composing the image capturing system 1 is usually utilized as a desk light. When the lighting apparatus 3 is utilized as the desk light, an input operation such as a pressing operation on the lighting switch 41 is performed in a state in which the power switch 42 is turned on. The input operation to this lighting switch 41 may be other than a strong depression and thus may be a tap on the lighting switch 41 or a contact (touch) with the lighting switch 41 depending on the form of the lighting switch 41.

When the control unit 45 recognizes that the lighting switch 41 is pressed, the control unit 45 turns on the Lighting LED 27. Accordingly, the Lighting LED 27 irradiates the irradiation range 8 with light, and the lighting apparatus 3 can light a part below the top unit 23 with irradiation light from the Lighting LED 27. To turn off the Lighting LED 27 in an ON state, an input operation such as a pressing operation on the lighting switch 41 is performed in a state in which the Lighting LED 27 is turned on. Accordingly, the control unit 45 turns off the Lighting LED 27.

In the image capturing system 1 according to the present embodiment, the lighting apparatus 3 is not only used as the desk light. The portable image capturing device 2 is set on the lighting apparatus 3, so that the portable image capturing device 2 can read the medium 6 disposed on the medium installation face 5 to scan the medium 6. The following describes the scanning operation on the medium 6 with the image capturing system 1. To scan the medium 6, the portable image capturing device 2 is mounted on the image-capturing-device mounting part 30 of the top unit 23 so that the image capturing unit 10 of the portable image capturing device 2 faces downward, the image capturing unit 10 is exposed from the top unit 23, and the display unit 11 faces upward.

The portable image capturing device 2 and the lighting apparatus 3 can transmit/receive information to/from each other by performing communication through the communication unit 15 of the portable image capturing device 2 and the communication unit 44 of the lighting apparatus 3. The portable image capturing device 2 can perform an photographing operation by receiving a control signal transmitted from the lighting apparatus 3. In the image capturing system 1, the pressing operation on the scan switch 40 is a trigger for starting the scanning. That is, turning on the scan switch 40 is the trigger for starting the scanning with the image capturing system 1. Due to such a configuration, the portable image capturing device 2 mounted on the top unit 23 of the lighting apparatus 3 continues a standby state until the communication unit 15 receives the trigger for starting the scanning from the lighting apparatus 3.

In this state, when the user presses the scan switch 40 of the lighting apparatus 3, the lighting apparatus 3 transmits the trigger for starting the scanning to the portable image capturing device 2. The trigger for starting the scanning is transmitted from the communication unit 44 of the lighting apparatus 3 and received by the communication unit 15 of the portable image capturing device 2. The portable image capturing device 2 that has received the trigger for starting the scanning performs an instruction for lighting the Lighting LED 27 included in the lighting apparatus 3. After receiving the instruction for lighting from the portable image capturing device 2, the lighting apparatus 3 keeps the ON state of the Lighting LED 27 when the Lighting LED 27 is in the ON state when the instruction for lighting is received, and turns on the Lighting LED 27 when the Lighting LED 27 is in an OFF state.

The portable image capturing device 2 photographs an image of the photographed area 7 on the medium installation face 5 with the image capturing unit 10 in the state in which the Lighting LED 27 is turned on, thereby the portable image capturing device 2 photographs the medium 6 in the photographed area 7, and stores the image data in the recording unit 17 of the portable image capturing device 2. Accordingly, under an optimal environment created by the Lighting LED 27 that is an illumination of its own, the image capturing system 1 photographs the medium 6 and stores the image data to scan the medium 6. To store the image data obtained by the scanning in the recording unit 17, image processing is performed on the image data with the control unit 18 of the portable image capturing device 2 to adjust image quality thereof appropriately, and the image data is recorded in the recording unit 17 to be stored.

The image capturing system 1 acquires image data of the medium 6 mounted on the photographed area 7 by photographing the photographed area 7 with the portable image capturing device 2 in a state in which the portable image capturing device 2 is mounted on the image-capturing-device mounting part 30 as described above, and the image-capturing-device mounting part 30 is formed of a plane. Accordingly, although the portable image capturing device 2 can be mounted on the image-capturing-device mounting part 30 with relatively high flexibility, the posture of the portable image capturing device 2, on the image-capturing-device mounting part 30, at which the portable image capturing device 2 can appropriately photograph the photographed area 7 is limited. That is, a desired image data cannot be obtained unless the portable image capturing device 2 is mounted on the image-capturing-device mounting part 30. Therefore, the image capturing system 1 according to the present embodiment detects a mounting state of the portable image capturing device 2 on the image-capturing-device mounting part 30, and notifies of the user of the mounting state where the portable image capturing device 2 is appropriately mounted, thereby enabling the user to perform appropriate photographing.

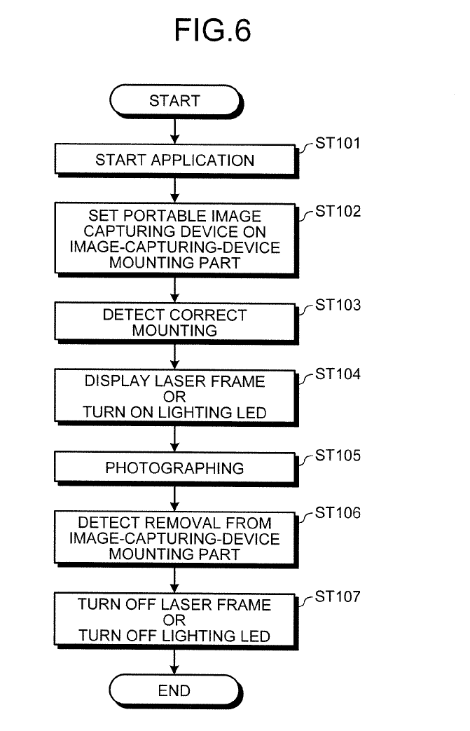

Next, a method for detecting and notifying of the placement state of the portable image capturing device 2 is described. FIG. 6 is a flowchart illustrating a processing procedure when photographing is performed with the image capturing system illustrated in FIG. 1. To perform photographing with the image capturing system 1, first, an application for the image capturing system 1, which is stored in the recording unit 17 of the portable image capturing device 2, is started before the portable image capturing device 2 is mounted on the image-capturing-device mounting part 30 (Step ST101).

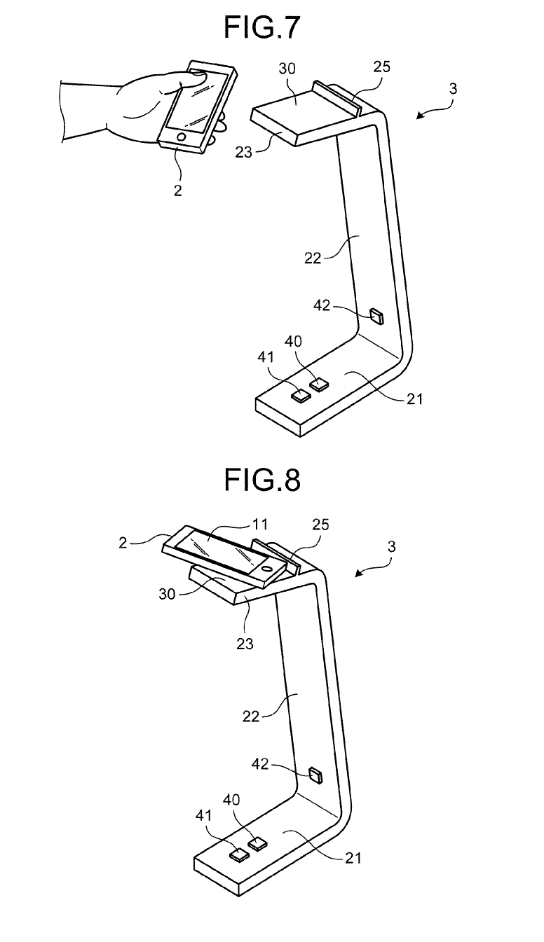

Next, the portable image capturing device 2 is set on the image-capturing-device mounting part 30 (Step ST102). FIG. 7 is an explanatory diagram when the portable image capturing device 2 is mounted on the image-capturing-device mounting part 30. To set the portable image capturing device 2 on the image-capturing-device mounting part 30, a user of the image capturing system 1 manually mounts the portable image capturing device 2 on empty image-capturing-device mounting part 30 of the lighting apparatus 3.

Next, the image capturing system 1 detects that the portable image capturing device 2 is mounted correctly (Step ST103). That is, in order to detect that the portable image capturing device 2 is correctly mounted on the image-capturing-device mounting part 30, the posture of the portable image capturing device 2 is detected by the posture detection sensor 13 included in the portable image capturing device 2, to determine whether the portable image capturing device 2 is mounted on the image-capturing-device mounting part 30 in an appropriate posture.

FIG. 8 is an explanatory diagram when the portable image capturing device 2 is inappropriately mounted. For example, as illustrated in FIG. 8, when the portable image capturing device 2 is mounted on the image-capturing-device mounting part 30 such that an end thereof at which the image capturing unit 10 is positioned projects to a side of the top part 23, it is not determined that the portable image capturing device 2 is mounted correctly. That is, when the posture of the portable image capturing device 2 detected by the posture detection sensor 13 is other than the posture correctly mounted on the image-capturing-device mounting part 30, the control unit 18 of the portable image capturing device 2 determines that the portable image capturing device 2 is not correctly mounted.

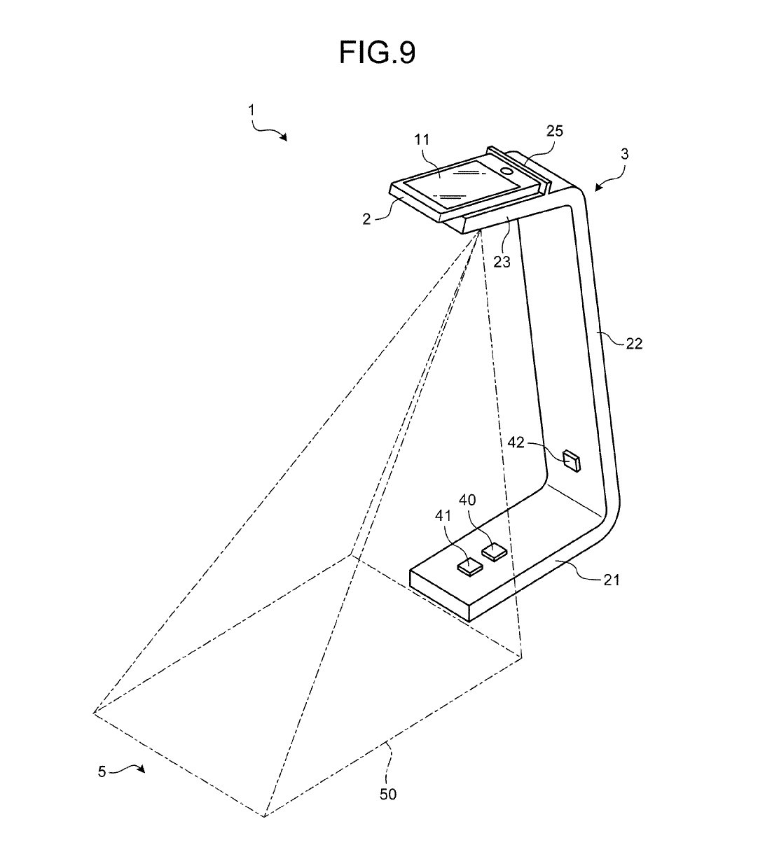

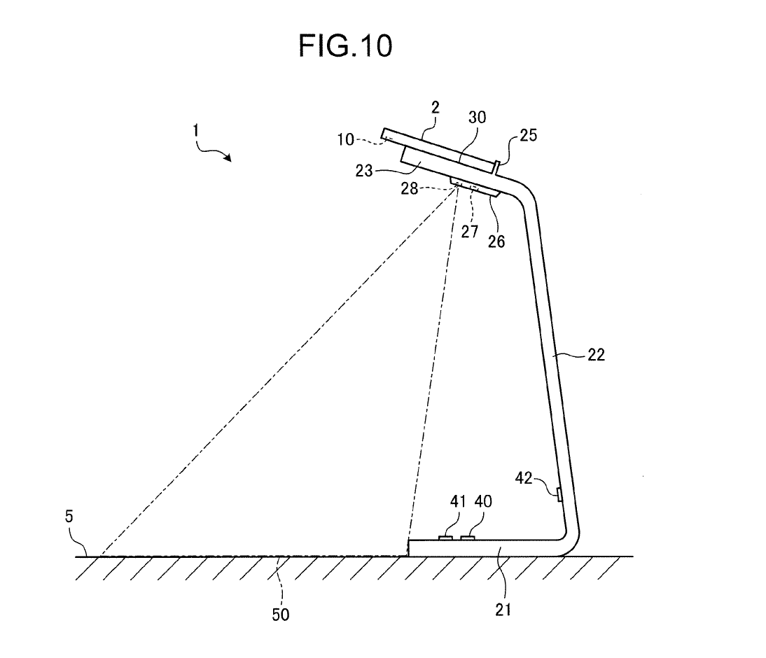

FIG. 9 is a perspective view when the portable image capturing device 2 is appropriately mounted on the image-capturing-device mounting part 30. FIG. 10 is a side view when the portable image capturing device 2 is appropriately mounted on the image-capturing-device mounting part 30. In such a state, when the posture of the portable image capturing device 2 detected by the posture detection sensor 13 is the posture correctly mounted on the image-capturing-device mounting part 30, the control unit 18 of the portable image capturing device 2 determines that the portable image capturing device 2 is correctly mounted on the image-capturing-device mounting part 30. In this way, when it is detected that the portable image capturing device 2 is correctly mounted based on the detection result by the posture detection sensor 13, a laser frame 50 is displayed or the Lighting LED 27 is turned on subsequently (Step ST104).

That is, when it is detected that the portable image capturing device 2 is correctly mounted, communication between the communication unit 15 of the portable image capturing device 2 and the communication unit 44 of the lighting apparatus 3 is performed, and the portable image capturing device 2 transmits a signal indicating that the portable image capturing device 2 is correctly mounted to the lighting apparatus 3. When receiving the signal, the control unit 45 of the lighting apparatus 3 causes the laser irradiation unit 28 to emit laser light to display the laser frame 50, or causes the Lighting LED 27 to be turned on with a light quantity suitable for photographing.

The following describes the laser frame 50 created by emitting laser light from the laser irradiation unit 28. The laser irradiation unit 28 irradiates the medium installation face 5 with linear laser light from the lower side of the top part 23 to display the laser frame 50, which is a substantially rectangular frame, on the medium installation face 5. That is, the laser irradiation unit 28 projects line of the laser light, i.e. the linear laser light, corresponding to each of sides of the substantially rectangular laser frame 50. The laser light corresponding to each side thereof is emitted on the medium installation face 5, so that a portion irradiated with the laser light on the medium installation face 5 is brightened. Accordingly, the laser frame 50 that is brightened and has the substantially rectangular shape is displayed on the medium installation face 5.

The laser frame 50 is an area that can be photographed by the image capturing unit 10 in a state in which the portable image capturing device 2 has a predetermined posture with respect to the image-capturing-device mounting part 30, that is, in a state in which the portable image capturing device 2 is correctly mounted on the image-capturing-device mounting part 30. Specifically, the laser frame 50 has a shape close to that of the photographed area 7 of the image capturing unit 10 excluding a region behind the front end of the base part 21 therefrom. The laser irradiation unit 28 for displaying such a laser frame 50 emits the laser light having the substantially rectangular-frame shape on the medium installation face 5 so that the laser light forms the laser frame 50 on the medium installation face 5 when the laser light is incident on the medium installation face 5.

To turn on the Lighting LED 27 with the light quantity suitable for photographing, for example, a duty ratio of pulse width modulation (PWM) control is set to 100% in a case in which the light quantity of the Lighting LED 27 can be adjusted by PWM control. Alternatively, when the Lighting LED 27 is equipped with a Lighting LED 27 that emits white light and a Lighting LED 27 that emits warm-color light, the Lighting LED 27 that emits white light is turned on. When it is detected that the portable image capturing device 2 is put in a predetermined posture, the Lighting LED 27 is turned on as described above to be in a lighting state in photographing by the image capturing unit 10.

By visually confirming the laser frame 50 or the irradiation light from the Lighting LED 27, the user of the image capturing system 1 can recognize that the portable image capturing device 2 is mounted on the image-capturing-device mounting part 30 in an appropriate posture. As described above, the laser irradiation unit 28 and the Lighting LED 27 are provided also as a notification unit that notifies the user that the posture detection sensor 13 detects that the portable image capturing device 2 is put in the predetermined posture with respect to the image-capturing-device mounting part 30 by emitting the laser light or the irradiation light.

As described above, when the laser frame 50 is displayed or the Lighting LED 27 is turned on in the lighting state in photographing, photographing is performed based on an photographing instruction from the user (Step ST105). That is, when the user is in a state in which he/she can recognize that the portable image capturing device 2 is correctly mounted on the image-capturing-device mounting part 30 by visually confirming the laser frame 50 or visually confirming the irradiation light from the Lighting LED 27 being suitable for photographing, a pressing operation on the scan switch 40 by the user is waited.

When the user instructs to start photographing by the image capturing unit 10 by pressing the scan switch 40, the communication between the communication unit 44 of the lighting apparatus 3 and the communication unit 15 of the portable image capturing device 2 is performed, and a signal indicating that start of photographing is instructed is transmitted to the portable image capturing device 2. When receiving the signal, the control unit 18 of the portable image capturing device 2 controls the image capturing unit 10 to perform photographing therewith. In this case, the lighting apparatus 3 interrupts the irradiation of the laser light from the laser irradiation unit 28 and turns off the laser frame 50. Accordingly, the image capturing unit 10 performs photographing in a state in which the laser frame 50 is not displayed. When the photographing is completed, the communication between the communication unit 15 of the portable image capturing device 2 and the communication unit 44 of the lighting apparatus 3 is performed to display the laser frame 50 again.

The control unit 18 of the portable image capturing device 2 that performs photographing as described above acquires a detection result from the posture detection sensor 13 as needed, and determines whether the portable image capturing device 2 is detached from the image-capturing-device mounting part 30. When the control unit 18 detects that the portable image capturing device 2 is detached or removed from the image-capturing-device mounting part 30 based on the detection result from the posture detection sensor 13 (Step ST106), the laser frame 50 is turned off or the Lighting LED 27 is turned off (Step ST107).

That is, when the portable image capturing device 2 detects that the portable image capturing device 2 is detached from the image-capturing-device mounting part 30, the communication unit 15 of the portable image capturing device 2 communicates with the communication unit 44 of the lighting apparatus 3, and the portable image capturing device 2 transmits a signal indicating that the portable image capturing device 2 is detached from the image-capturing-device mounting part 30 to the lighting apparatus 3. When receiving the signal, the control unit 45 of the lighting apparatus 3 stops the irradiation of the laser light from the laser irradiation unit 28, or restores the lighting state of the Lighting LED 27 to a lighting state before being switched to the lighting state suitable for photographing.

As described above, the image capturing system 1 detects whether the portable image capturing device 2 is correctly mounted on the image-capturing-device mounting part 30. When the portable image capturing device 2 is correctly mounted on the image-capturing-device mounting part 30, the image capturing system 1 notifies the user of this fact for the image capturing system to perform photographing appropriately. In this case, it is not necessary to perform both of the display of the laser frame 50 and the turning on of the Lighting LED 27 with the light quantity suitable for photographing, any one of which may be sufficient, to make a notification to the user.

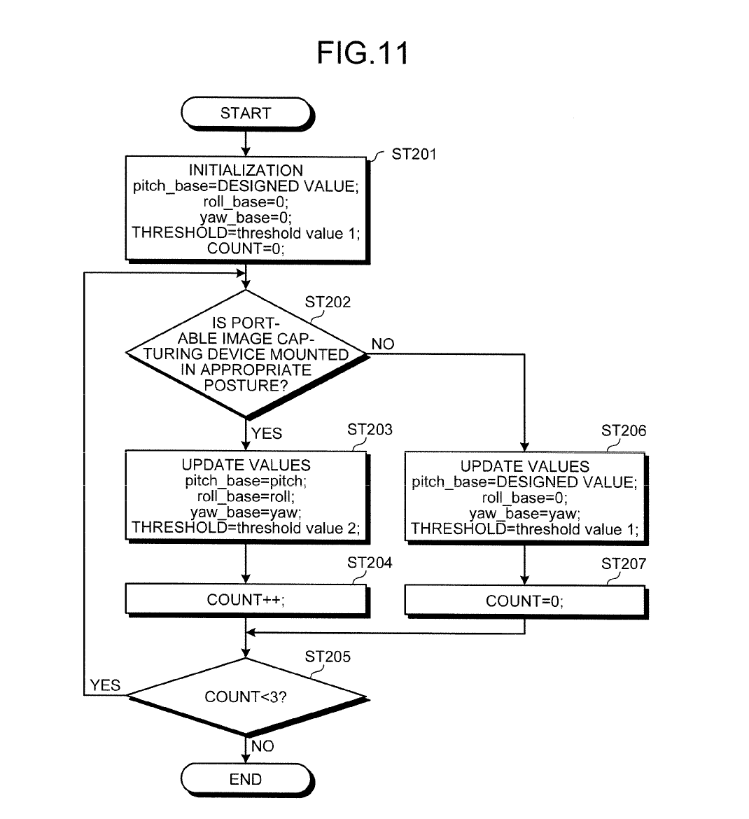

Next, in the case of performing the photographing with the image capturing system 1 as described above, the following describes a method for detecting that the portable image capturing device 2 is mounted on the image-capturing-device mounting part 30, and for detecting that the portable image capturing device 2 mounted on the image-capturing-device mounting part 30 is removed or detached. FIG. 11 is a flowchart illustrating a processing procedure in a case of detecting that the portable image capturing device is mounted on the image-capturing-device mounting part. First, the following describes the method for detecting that the portable image capturing device 2 is mounted on the image-capturing-device mounting part 30. When performing the detection, first, each value to be used for the detection is initialized (Step ST201).

Specifically, pitch_base that is a tilt angle in the longitudinal direction of the portable image capturing device 2 is set to a designed value, roll_base that is a tilt angle in the width direction of the portable image capturing device 2 is set to 0, and yaw_base that is a rotation angle around a rotation axis extending in the thickness direction of the portable image capturing device 2 is set to 0. In this case, the designed value for the pitch_base indicates an angle of the top part 23 tilted with respect to the horizontal direction, and when the angle is 15° for example, the designed value is 15°.

THRESHOLD used for determining a posture state of the portable image capturing device 2 is set to threshold value 1, and COUNT used for measuring elapsed time is set to 0. In this case, the threshold value 1 for the THRESHOLD indicates a variation of value that affects each of values related to the posture of the portable image capturing device 2. Examples thereof include a variation in a degree of parallelization of the medium installation face 5 on which the lighting apparatus 3 is mounted, a variation in an angle of the image-capturing-device mounting part 30, and a variation in values detected by the posture detection sensor 13. The threshold value 1 is a total value of the above values. When the total value of a plurality of variations is ±5°, the threshold value 1 is 5°.

Next, the portable image capturing device 2 determines whether it is mounted on the image-capturing-device mounting part 30 in an appropriate posture (Step ST202). The determination is made based on whether differences between the initialized pitch_base, roll_base, and yaw_base and respective sensor values of pitch, roll, and yaw detected by the posture detection sensor 13 are less than the THRESHOLD. That is, with respect to each of the pitch, roll, and yaw, a determination of |reference value−sensor value|<THRESHOLD is made, respectively. Specifically, determinations are made as represented by the following expressions (1) to (3).

|pitch_base−pitch|<THRESHOLD (1)

|roll_base−roll|<THRESHOLD (2)

|yaw_base−yaw|<THRESHOLD (3)

According to the determination, when all of the values of pitch, roll, and yaw satisfy a condition of |reference value−sensor value|<THRESHOLD, and it is determined that the portable image capturing device 2 is mounted in an appropriate posture (Yes at Step ST202), each of the values is updated subsequently (Step ST203). That is, the reference values are replaced with respective sensor values as follows: pitch_base=pitch, roll_base=roll, and yaw_base=yaw. The THRESHOLD is set to threshold value 2. In this case, the threshold value 2 is a value indicating whether the portable image capturing device 2 is stationary. The threshold value 2 also indicates a tolerable amount of variation in each of the values when the values of pitch, roll, and yaw are slightly changed due to a slight vibration and the like in the state in which the portable image capturing device 2 is mounted on the image-capturing-device mounting part 30.

After each of the values is updated as described above, COUNT++ is calculated (Step ST204). That is, the COUNT is incremented.

After the COUNT++ is calculated, it is determined whether COUNT<3 is satisfied (Step ST205). When it is determined that COUNT<3 is not satisfied (No at Step ST205), that is, it is determined that COUNT≧3 is satisfied, the portable image capturing device 2 determines that it is mounted on the image-capturing-device mounting part 30 in an appropriate posture and in a stationary state for a predetermined time. Accordingly, the portable image capturing device 2 determines that the portable image capturing device 2 is appropriately mounted on the image-capturing-device mounting part 30 and exits from the processing procedure.

On the other hand, when it is determined that COUNT<3 is satisfied (Yes at Step ST205), since the predetermined time for determining the stationary state has not elapsed yet, the process returns to Step ST202 to be continued.

In contrast, when any one of the values of pitch, roll, and yaw fails to satisfy the condition of reference value−sensor value|<THRESHOLD, and it is determined that the portable image capturing device 2 is mounted in an inappropriate posture (No at Step ST202), the values are also updated. In this case, the update is performed with values different from those in the case in which the portable image capturing device 2 is mounted in an appropriate posture (Step ST206). In this case, the values are updated such that the designed value is maintained with respect to the pitch_base, and with respect to the roll_base and the yaw_base, the roll_base and the yaw_base are updated to roll_base−0, and yaw_base=yaw, respectively. The threshold value 1 is also maintained with respect to the THRESHOLD. That is, when it is determined that the portable image capturing device 2 is mounted in an inappropriate posture, the values are continued to be set for determining whether the portable image capturing device 2 is mounted in an appropriate posture by maintaining the pitch_base and the THRESHOLD at the initial setting values.

After each of the values is updated as described above, COUNT=0 is set subsequently (Step ST207). After COUNT=0 is set, it is determined whether COUNT<3 is satisfied (Step ST205). When it is determined that COUNT<3 is not satisfied (No at Step ST205), the portable image capturing device 2 determines that it is appropriately mounted on the image-capturing-device mounting part 30 and exits from or ends this processing procedure. When it is determined that COUNT<3 is satisfied (Yes at Step ST205), the process returns to Step ST202 to be continued.

As described above, in detecting the mounting of the portable image capturing device 2 on the image-capturing-device mounting part 30, it is determined that the portable image capturing device 2 is appropriately mounted on the image-capturing-device mounting part 30 when the portable image capturing device 2 is put in an appropriate posture and such a state is maintained for a predetermined time.

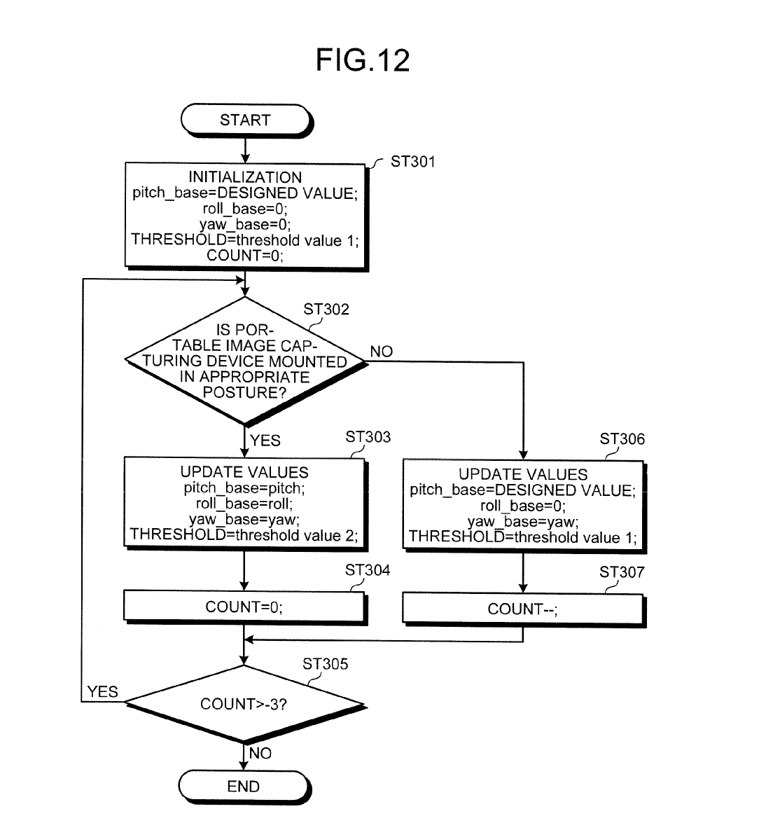

Next, the following describes the method for detecting that the portable image capturing device 2 mounted on the image-capturing-device mounting part 30 is removed or detached. FIG. 12 is a flowchart illustrating a processing procedure in a case of detecting that the portable image capturing device 2 is removed or detached from the image-capturing-device mounting part 30. In detecting that the portable image capturing device 2 is removed from the image-capturing-device mounting part 30, each value used for the detection is initialized similarly to the case of detecting that the portable image capturing device 2 is mounted (Step ST301). Specifically, the values are set as follows: pitch_base=designed value, roll_base=0, yaw_base=0, THRESHOLD=threshold value 1, and COUNT=0.

Next, the portable image capturing device 2 determines whether it is mounted on the image-capturing-device mounting part 30 in an appropriate posture (Step ST302). With respect to each of the sensor values of the pitch, roll, and yaw detected by the posture detection sensor 13, the determination of |reference value−sensor value|<THRESHOLD is made respectively, that is, the determination is made as represented by the expressions (1) to (3) described above.

According to the determination, when all of the values of pitch, roll, and yaw satisfy the condition of |reference value−sensor value|<THRESHOLD, and it is determined that the portable image capturing device 2 is mounted in an appropriate posture (Yes at Step ST302), each of the values is updated subsequently (Step ST303). Specifically, the values are set as follows: pitch_base=pitch, roll_base=roll, yaw_base=yaw, and THRESHOLD=threshold value 2.

After each of the values is updated as described above, COUNT=0 is set subsequently (Step ST304). After COUNT=0 is set, it is determined whether COUNT>−3 is satisfied (Step ST305). When it is determined that COUNT>−3 is satisfied (Yes at Step ST305), the process returns to Step ST302 to be continued.

In contrast, when any one of the values of pitch, roll, and yaw fails to satisfy the condition of |reference value− sensor value|<THRESHOLD, and it is determined that the portable image capturing device 2 is mounted in an inappropriate posture (No at Step ST302), the update is performed with values different from those in the case in which the portable image capturing device 2 is mounted in an appropriate posture (Step ST306). In this case, the values are updated as follows: pitch_base=designed value, roll_base−0, yaw_base=yaw, and THRESHOLD=threshold 1.

After each of the values is updated as described above, COUNT−− is calculated (Step ST307). That is, the COUNT is decremented.

After the COUNT−− is calculated, it is determined whether COUNT>−3 is satisfied (Step ST305). When it is determined that COUNT>−3 is not satisfied (No at Step ST305), that is, it is determined that COUNT≦−3 is satisfied, the portable image capturing device 2 determines that it is mounted on the image-capturing-device mounting part 30 in an inappropriate posture for a predetermined time. Accordingly, the portable image capturing device 2 determines that the portable image capturing device 2 is removed from the image-capturing-device mounting part 30 and ends or exits from the processing procedure.

On the other hand, when it is determined that COUNT>−3 is satisfied (Yes at Step ST305), even when the portable image capturing device 2 is mounted on the image-capturing-device mounting part 30 in an inappropriate posture, since the predetermined time for determination has not elapsed yet, the process returns to Step ST302 to be continued.

As described above, in detecting the removal or detachment of the portable image capturing device 2 from the image-capturing-device mounting part 30, it is determined that the portable image capturing device 2 is removed from the image-capturing-device mounting part 30 when the portable image capturing device 2 is caused to be in an inappropriate posture and such a state is maintained for a predetermined time.

In the image capturing system 1 according to the embodiment described above, when the posture detection sensor 13 detects that the portable image capturing device 2 is put in the predetermined posture with respect to the image-capturing-device mounting part 3C in a state in which the image capturing unit 10 of the portable image capturing device 2 can perform photographing, the laser light is emitted from the laser irradiation unit 28 to display the laser frame 50, and the Lighting LED 27 is turned on with the light quantity suitable for photographing. Accordingly, because the user can learn that the Portable image capturing device 2 is appropriately mounted, the user can place the portable image capturing device 2 on the image-capturing-device mounting part 30 in an appropriate posture by visually confirming the light. In this way, it is possible to easily provide a state in which the portable image capturing device 2 is appropriately mounted on the image-capturing-device mounting part 30.

The laser irradiation unit 28, which displays the laser frame 50 indicating the photographed area by the image capturing unit 10 on the medium installation face 5, is used as the notification unit that notifies that the portable image capturing device 2 is in the predetermined posture with respect to the image-capturing-device mounting part 30. Accordingly, the user can learn that the portable image capturing device 2 is mounted in an appropriate posture and also notified of an area that can be photographed by the image capturing unit 10. In this way, usability of the image capturing system 1 in photographing can be improved.

Also, the Lighting LED 27 which can be made to be in the lighting state when the image capturing unit 10 performs photographing is used as the notification unit that notifies that the portable image capturing device 2 is in the predetermined posture with respect to the image-capturing-device mounting part 30. Accordingly, the user can learn that the portable image capturing device 2 is put in an appropriate posture and the photographed area 7 can be irradiated with the light quantity suitable for photographing by the image capturing unit 10. In this way, image quality of the photographed image can be improved while improving facility of mounting the portable image capturing device 2 in an appropriate posture.

Modification

In the image capturing system according to the embodiment described above, the laser irradiation unit 28 and the Lighting LED 27 are used as the notification unit that notifies the user that the portable image capturing device 2 is put in the predetermined posture. However, other component may be used as the notification unit. Examples of the notification unit include the scan switch 40 serving as the photographing instruction unit for instructing the image capturing unit 10 to start photographing. In this case, the scan switch 40 is configured to be capable of emitting light and changes a blinking state thereof depending on whether the portable image capturing device 2 is in the predetermined posture to notify the user that the portable image capturing device 2 is mounted in the predetermined posture.

The notification unit may make a notification using an alarm, or by causing the Lighting LED 27 to blink. As described herein, any configuration and any method may be used for the notification unit so long as it can notify the user that, when the portable image capturing device 2 is mounted on the image-capturing-device mounting part 30, the portable image capturing device 2 is mounted in the predetermined posture.

In the image capturing system 1 described above, although the image data photographed by the portable image capturing device 2 is stored in the recording unit 17 of the portable image capturing device 2, the image data may be stored in any place other than the portable image capturing device 2. For example, after performing photographing with the portable image capturing device 2, the image data may be transferred to the lighting apparatus 3 and stored therein, or may be transferred to an external server and stored therein.

In the image capturing system 1 described above, although a smartphone is exemplified as the portable image capturing device 2 for photographing the medium 6 disposed on the medium installation face 5, any device other than the smartphone may be used as the portable image capturing device 2. The portable image capturing device 2 may be, for example, a digital camera having a function for communicating with the lighting apparatus 3. The portable image capturing device 2 may have any configuration so long as it can perform photographing based on a scanning trigger transmitted from the lighting apparatus 3 by communicating with the lighting apparatus 3.

The image capturing system according to the present invention can easily provide a state in which the portable image capturing device is appropriately mounted on the image-capturing-device mounting face.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image capturing system comprising:
a portable image capturing device including
an image capturing unit,
a posture detection sensor that detects a posture of the portable image capturing device, and
a control unit that controls the portable image capturing device; and
a lighting apparatus including
a base part to be disposed on a medium installation face on which a medium is mounted,
an arm part extending upward from the base part,
a top part extending from the arm part and facing the medium installation face,
an image-capturing-device mounting part arranged on the top part to mount the portable image capturing device thereon enabling the image capturing unit to photograph the medium installation face,
a lighting unit that irradiates the medium installation face with light,
a communication unit that performs mutual communication between the lighting apparatus and the portable image capturing device, and
a notification unit that makes a notification when the posture detection sensor detects that the portable image capturing device is mounted in a predetermined posture with respect to the image-capturing-device mounting part in a state in which the image capturing unit is capable of performing photographing controlled by the control unit.

2. The image capturing system according to claim 1, wherein the notification unit is an area display unit that displays an area to be photographed by the image capturing unit on the medium installation face in a state in which the portable image capturing device is mounted in the predetermined posture with respect to the image-capturing-device mounting part.

3. The image capturing system according to claim 1, wherein
the notification unit is an photographing instruction unit that instructs the image capturing unit to start photographing, and
a blinking state of the photographing instruction unit is changed depending on whether the portable image capturing device is in the predetermined posture.

4. The image capturing system according to claim 1, wherein
the notification unit is the lighting unit, and
the lighting unit is caused to be in a lighting state in photographing by the image capturing unit when detecting that the portable image capturing device is mounted in the predetermined posture.
